(19) United States
(12) Patent Application Publication
(10) Pub. No.: US 2021/0308722 A1
(43) Pub. Date: Oct. 7, 2021

(54) SYSTEM AND METHOD FOR TRANSFERRING PARCELS FROM A FIRST CONVEYOR TO A SECOND CONVEYOR

(71) Applicant: Material Handling Systems, Inc., Mt. Washington, KY (US)

(72) Inventors: Thomas Anthony Hillerich, JR., Louisville, KY (US); Michael Alan McCue, Louisville, KY (US)

(21) Appl. No.: 17/209,345

(22) Filed: Mar. 23, 2021

Related U.S. Application Data
(60) Provisional application No. 63/004,675, filed on Apr. 3, 2020.

(51) Int. Cl. B07C 1/04; B65G 47/90; B65G 43/00; G06K 9/00; G06K 9/78

(52) U.S. Cl. CPC B07C 1/04; B65G 47/90; B65G 43/00; B65G 2203/041; G06K 9/78; B65G 2203/0233; G06K 9/00201

(57) ABSTRACT

In a system and method for identifying and transferring parcels from a first conveyor to a second conveyor aligned with the first conveyor, a camera of a vision and control subsystem is used to acquire image data of a bulk flow of multiple parcels on the first conveyor. The image data is processed by a computer of the vision and control subsystem to identify individual parcels in the bulk flow of multiple parcels. The computer then activates a robot to engage and transfer selected individual parcels in the bulk flow of multiple parcels in a predetermined sequence. After the robot has engaged and transferred the selected individual parcels, the computer communicates instructions to the first conveyor to advance remaining parcels in the bulk flow of multiple parcels on the first conveyor to the second conveyor.

### CROSS-REFERENCE TO RELATED APPLICATIONS

The present application claims priority to U.S. Patent Application Ser. No. 63/004,675 filed on Apr. 3, 2020, the entire disclosure of which is incorporated herein by reference.

### BACKGROUND OF THE INVENTION

The present invention relates to the handling of parcels within a sorting or similar facility.

In a sorting facility for parcels, various parcels are unloaded from trucks or other vehicles at unloading locations, sorted, and then loaded onto trucks or other vehicles at loading locations for delivery to the intended recipients. Thus, within the sorting facility, there is often a complex system of conveyors and equipment that facilitates transport and sorting of the various parcels within the facility.

When first introduced into the system of conveyors and equipment, the parcels are randomly positioned on a conveyor in a “bulk flow.” Thus, within the sorting facility, the first step is often to transform the bulk flow into a singulated flow of parcels in which the parcels are positioned at substantially equal intervals and aligned (i.e., in a single file line) along a conveyor for subsequent processing. A wide variety of singulators exists in the art, many of which employ various combinations of belt conveyors and/or roller conveyors to achieve the desired singulation of the parcels. However, there are certain deficiencies in such prior art systems. For example, a surge in the volume of parcels may overwhelm the mechanical systems, and parcels may not be fully singulated. Non-singulated parcels may then interfere with subsequent processing, including downstream sorting.

U.S. Pat. No. 10,646,898, which is incorporated herein by reference, thus describes a system and method for identifying and transferring parcels from a bulk flow on the first conveyor (or “pick conveyor”) to a singulated stream of parcels on the second conveyor (or “place conveyor”). Specifically, a robot singulator (or robot) receives parcels via the first conveyor, engages each parcel, and then places it onto the second conveyor. The robot singulator thus includes an end effector with a means for engaging the selected parcel. For example, the end effector may include one or more vacuum cups for engaging the selected parcel. The end effector is mounted on a framework, which is controlled to move and position the end effector. To position the framework and the end effector to engage the selected parcel, the system also includes a vision and control subsystem associated with the robot. The vison and control subsystem includes one or more cameras that are operably connected to a computer for receiving and processing image data. Specifically, the one or more cameras are used to generate a three-dimensional representation of the parcels. Parcels are identified in the three-dimensional representation, and the computer then communicates instructions to position the robot such that the end effector can engage and manipulate each parcel.

However, rather than engaging and transferring each and every parcel on the first conveyor to a singulated stream of parcels on the second conveyor, in some cases, it may be more efficient to only engage certain parcels, while conveying other parcels directly through from the first conveyor to the second conveyor.

### SUMMARY OF THE INVENTION

The present invention is a system and method for transferring parcels from a first conveyor to a second conveyor, and, more particularly, a system and method for engaging only certain parcels, while conveying other parcels directly through from the first conveyor to the second conveyor.

In an exemplary system for transferring parcels from a first conveyor to a second conveyor made in accordance with the present invention, the first conveyor (or “pick conveyor”) is aligned with the second conveyor (or “place conveyor”). In other words, a distal end of the first conveyor is adjacent to a proximal end of the second conveyor. The first conveyor carries a bulk flow of parcels. A robot is positioned at the interface between the first conveyor and the second conveyor. The robot can selectively engage individual parcels in the bulk flow of parcels on the first conveyor, engaging each selected parcel and placing it on the second conveyor.

In use, as the bulk flow of parcels approaches the interface between the first conveyor and the second conveyor, the first conveyor is stopped and remains stationary while the robot selectively engages individual parcels in the bulk flow of parcels on the first conveyor, engaging each selected parcel and placing it on the second conveyor. In order to identify the individual parcels for transfer, the exemplary system also includes a vison and control subsystem. The vision and control subsystem includes a camera, which is operably connected to a computer. The computer receives and processes image data from the camera. In this regard, the computer includes a processor for executing instructions (routines) stored in a memory component or other computer-readable medium. With respect to such processing of the image data, the computer receives the image data from the camera and then analyzes the image data to identify parcels. Once the parcels have been identified, the computer communicates instructions to the robot to engage and transfer selected individual parcels in the bulk flow of multiple parcels from the first conveyor to the second conveyor.

The vison and control subsystem also controls movement of the first conveyor. After the robot has engaged and transferred selected individual parcels in the bulk flow of multiple parcels from the first conveyor to the second conveyor, the computer communicates instructions to the first conveyor to advance remaining parcels in the bulk flow of multiple parcels on the first conveyor to the second conveyor.

In some embodiments, the first conveyor includes multiple conveyor segments, with each of the multiple conveyor segments being independently controlled by and receiving instructions from the computer. In such embodiments, the computer communicates instructions to engage and transfer selected individual parcels in the bulk flow of multiple parcels from either (i) one of the multiple conveyor segments of the first conveyor to another of the multiple conveyor segments of the first conveyor, or (ii) the first conveyor to the second conveyor.

### DESCRIPTION OF THE DRAWINGS

FIG. 1 is a partial perspective view of an exemplary system for transferring parcels from a first conveyor to a second conveyor made in accordance with the present invention;

FIG. 2 is a perspective view of a robot singulator used in the exemplary system of FIG. 1;

FIG. 3 is a schematic diagram of an exemplary vison and control subsystem according to the system and method of the present invention;

FIG. 4 is an exemplary flow chart for a “Parcel Detection and Target Selection” routine according to the system and method of the present invention;

FIGS. 5A-5I are a sequence of schematic diagrams, illustrating the transfer of selected parcels from the first conveyor to the second conveyor in one exemplary implementation of the present invention;

FIGS. 6A-6F are a sequence of schematic diagrams, illustrating the transfer of selected parcels from a first conveyor to a second conveyor in another exemplary implementation of the present invention;

FIGS. 7A-7G are a sequence of schematic diagrams, illustrating the transfer of selected parcels from a first conveyor to a second conveyor in another exemplary implementation of the present invention;

FIGS. 8A-8G are a sequence of schematic diagrams, illustrating the transfer of selected parcels from a first conveyor to a second conveyor in another exemplary implementation of the present invention; and

FIGS. 9A-9F are a sequence of schematic diagrams, illustrating the transfer of selected parcels from a first conveyor to a second conveyor in another exemplary implementation of the present invention.

### DETAILED DESCRIPTION OF THE INVENTION

The present invention is a system and method for transferring parcels from a first conveyor to a second conveyor, and, more particularly, a system and method for engaging only certain parcels, while conveying other parcels directly through from the first conveyor to the second conveyor.

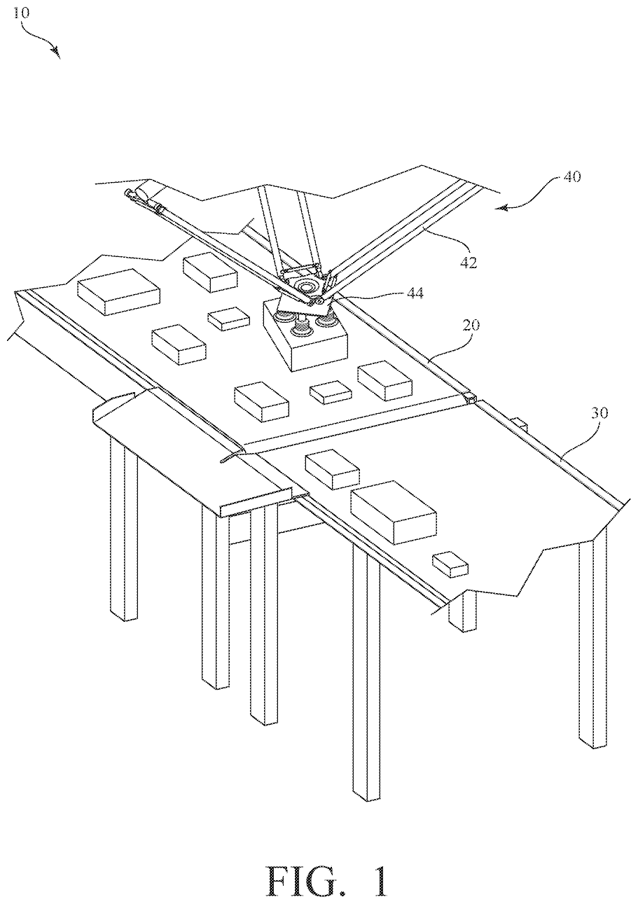

FIG. 1 is a partial perspective view of an exemplary system 10 for transferring parcels from a first conveyor 20 to a second conveyor 30 made in accordance with the present invention. As shown, the first conveyor (or “pick conveyor”) 20 is aligned with the second conveyor (or “place conveyor”) 30. In other words, a distal end of the first conveyor 20 is adjacent to a proximal end of the second conveyor 30. The first conveyor 20 carries a bulk flow of parcels. A robot 40 is positioned at the interface between the first conveyor 20 and the second conveyor 30. The robot 40 can selectively engage individual parcels in the bulk flow of parcels on the first conveyor 20, engaging each selected parcel and placing it on the second conveyor 30.

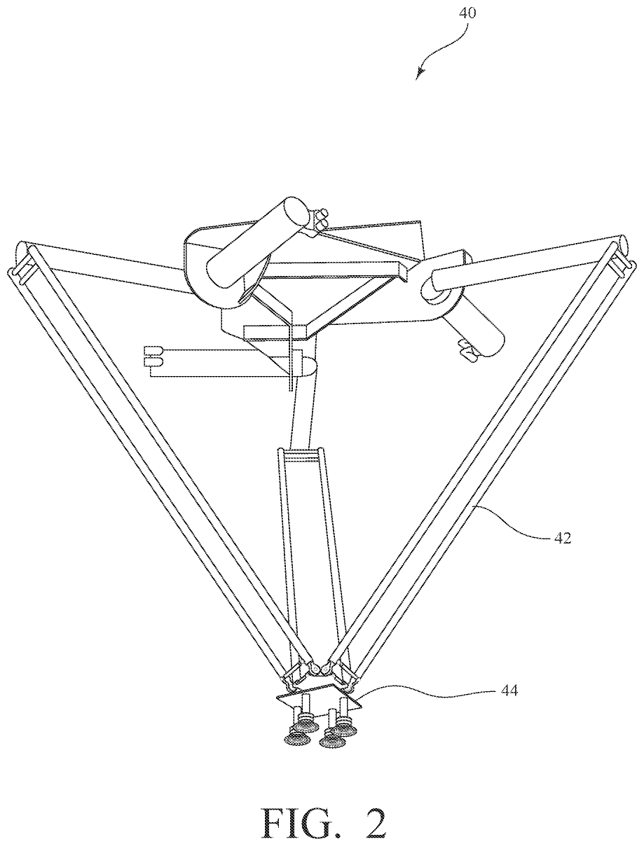

Referring now to FIG. 2 (and similar to the robot singulator described in U.S. Pat. No. 10,646,898), the robot 40 includes an end effector 44 with a means for engaging a selected parcel. In this exemplary embodiment, the end effector 44 includes one or more vacuum cups for engaging the selected parcel; however, other forms of end effectors (for example, actuated grippers, electrostatic adhesion means, and pushing/sweeping implements) could also be incorporated into the robot 40.

Referring still to FIG. 2 (and similar to the robot singulator described in U.S. Pat. No. 10,646,898), the end effector 44 is mounted on a framework 42, which is controlled to move and position the end effector 44. Specifically, in this exemplary embodiment, the framework 42 has six degrees of freedom: (i) movement along the x-axis; (ii) movement along the y-axis; (iii) movement along the z-axis; (iv) rotation about the x-axis; (v) rotation about the y-axis; and (vi) rotation about the z-axis. Thus, the framework 42 can always be positioned for the end effector 44 to engage a selected parcel. To position the framework 42 and the end effector 44 to engage the selected parcel, the exemplary system also includes a vision and control subsystem associated with the robot 40, as further described below. For example, one suitable robot for use in the present invention is a Delta 3 P6 robot manufactured by Schneider Electric and available, for instance, from Advantage Industrial Automation of Duluth, Ga.

Referring again to FIG. 1, as the bulk flow of parcels approaches the interface between the first conveyor 20 and the second conveyor 30, the first conveyor 20 is stopped and remains stationary while the robot 40 selectively engages individual parcels in the bulk flow of parcels on the first conveyor 20, engaging each selected parcel and placing it on the second conveyor 30.

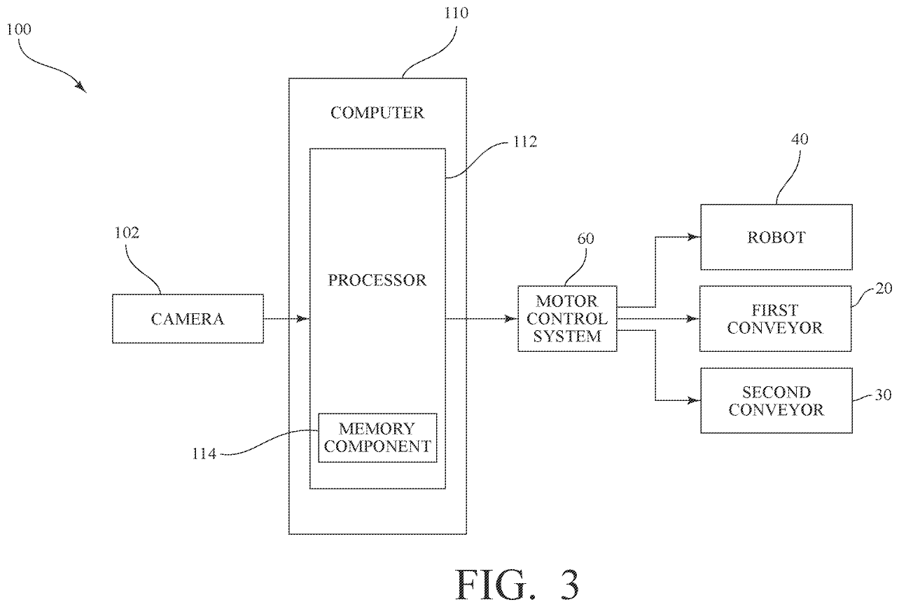

Referring now to FIG. 3 (and similar to the robot singulator described in U.S. Pat. No. 10,646,898), the exemplary system 10 also includes a vison and control subsystem 100. The vision and control subsystem 100 includes a camera 102, which is preferably positioned adjacent the robot 40 and is focused on bulk flow of parcels on the first conveyor 20, where a selected parcel is to be engaged by the end effector 44 of the robot 40. The camera 102 is operably connected to a computer 110, which receives and processes image data from the camera 102. In this regard, the computer 110 includes a processor 112 for executing instructions (routines) stored in a memory component 114 or other computer-readable medium. With respect to such processing of the image data, the computer 110 receives the image data from the camera 102 and then analyzes the image data to identify parcels.

For example, in one exemplary implementation and as illustrated in FIG. 4, a “Parcel Detection and Target Selection” routine may be used to identify parcels. First, the image data received from the camera 102 is used to generate a three-dimensional representation of the parcels on the first conveyor 20. In this regard, and as shown in FIG. 4, the camera 102 may actually acquire two-dimensional image data of the parcels and three-dimensional image data (e.g., in point-cloud data format) of the parcels, as indicated by inputs 200, 202 in FIG. 4. The two-dimensional image data and the three-dimensional image data are then subjected to a pre-processing step in order, if necessary, to correct or modify raw data received from the camera 102, as indicated by blocks 204, 206 in FIG. 4. Additionally, if both two-dimensional data and three-dimensional data are acquired by the camera 102, there is an additional step of data rectification, in which the two-dimensional data and three-dimensional data are indexed or transformed to a common coordinate system, as indicated by block 208 in FIG. 4. The final result is a three-dimensional representation of the parcels, as indicated by output 210 in FIG. 4.

Referring still to FIG. 4, parcels are then identified and segmented from the three-dimensional representation, as indicated by block 212. In this regard, it is contemplated that various image analysis techniques, machine learning techniques, and/or artificial intelligence techniques could be used to carry out the identification and segmentation of parcels from the three-dimensional representation. Once the parcels have been so identified, the parcels are then ranked for acquisition, as indicated by block 214. For example, in some implementations, a cost function may be applied to generate a ranked order of the parcels for acquisition by the robot 40, with the objective being to optimize pick rate and accuracy. However, as further discussed below, not all parcels are engaged by the robot 40 in this manner. Rather, some parcels are engaged by the robot 40, while other parcels are conveyed directly through from the first conveyor 20 to the second conveyor 30.

Referring still to FIG. 4, once the above-described routines have been carried out by the computer 110, and the parcels have been identified and ranked, the computer 110 communicates instructions to position the robot 40 such that the end effector 44 can engage and manipulate selected parcels according to the ranked order, as indicated by output 220.

Referring again to FIG. 3, the computer 110 communicates instructions to a motor control system 60 that controls operation of the robot 40. For example, suitable motor control systems for use in the present invention include: ControlLogix® controllers, which are part of the Allen-Bradley product line manufactured and distributed by Rockwell Automation, Inc. of

Milwaukee, Wis.; and PacDrive™ controllers manufactured and distributed by Schneider Electric Automation GmbH and Schneider Electric USA, Inc.

Referring again to FIG. 1, after receiving such instructions, the robot 40 then engages the selected parcel and transfers it from the first conveyor 20 to the second conveyor 30.

Referring again to FIG. 3, in this exemplary embodiment, the vison and control subsystem 100 also controls movement of the first conveyor 20. Specifically, as shown in FIG. 3, the motor control system 60 is thus also operably connected to and communicates with the first conveyor 20. Furthermore, in at least some embodiments of the present invention, the computer 110 communicates instructions to the motor control system 60 to selectively activate the second conveyor 30 to move parcels away from the robot 40, as further discussed below.

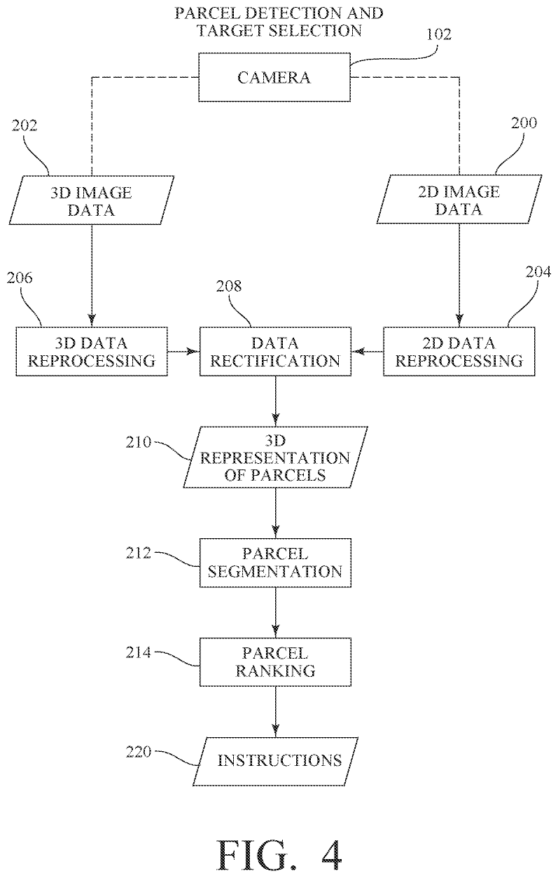

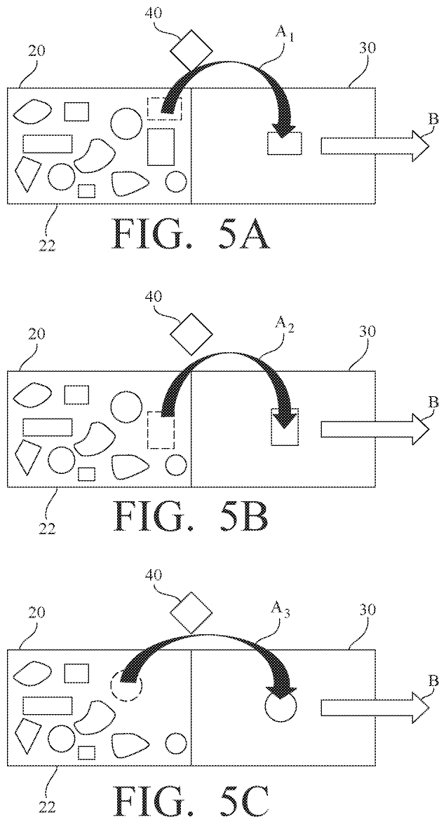

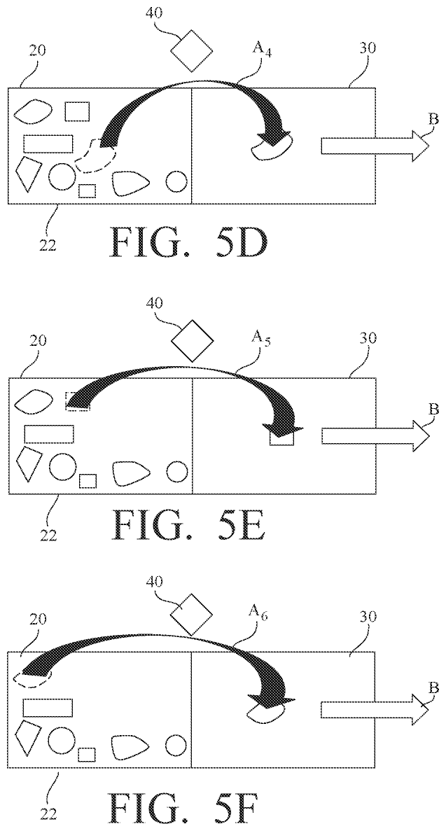

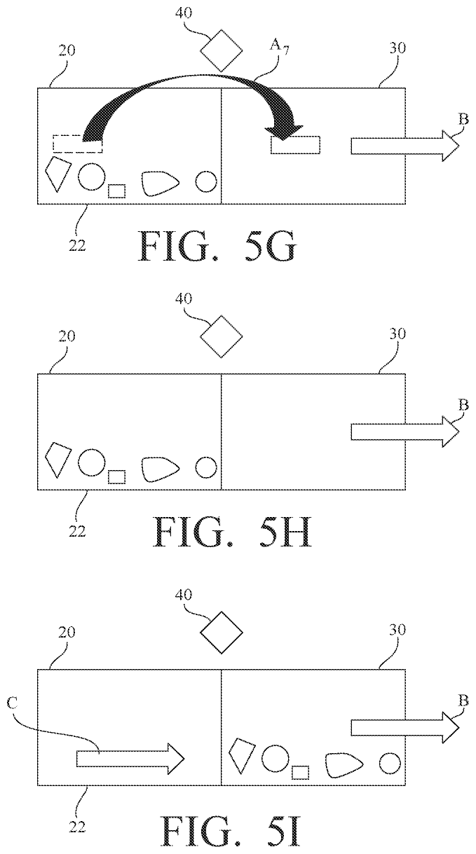

FIGS. 5A-5I are a sequence of schematic diagrams, illustrating the transfer of selected parcels from the first conveyor 20 to the second conveyor 30 in one exemplary implementation of the present invention. As shown in this sequence, the robot 40 selectively engages parcels in the bulk flow of parcels on the first conveyor 20, one-by-one, placing each selected parcel on the second conveyor 30. However, as shown, not all parcels are engaged by the robot 40 in this manner. Rather, some parcels are engaged by the robot 40, while other parcels are conveyed directly through from the first conveyor 20 to the second conveyor 30. Specifically, each of the parcels that is not positioned along a proximal edge 22 of the first conveyor 20 is engaged by the robot 40 and transferred to the second conveyor 30, as indicated by arrows A₁-A₇ in FIGS. 5A-5G. In this exemplary implementation, each parcel is placed on the second conveyor 30 at substantially the same location. However, as this transfer is occurring, the second conveyor 30 is activated (as indicated by arrow B) and thus moves each transferred parcel away from the robot 40 before transfer of the next parcel.

Referring now specifically to FIGS. 5H and 5I, after the above-described parcels have been transferred, there is a remaining line of parcels along the proximal edge 22 of the first conveyor 20. It is not necessary to engage these parcels with the robot 40. Rather, by activating the first conveyor 20 (as indicated by arrow C in FIG. 5I), the remaining parcels are conveyed directly through from the first conveyor 20 to the second conveyor 30. In this example, only seven of the twelve parcels were engaged by the robot 40, representing a 41% decrease in pick moves by the robot 40.

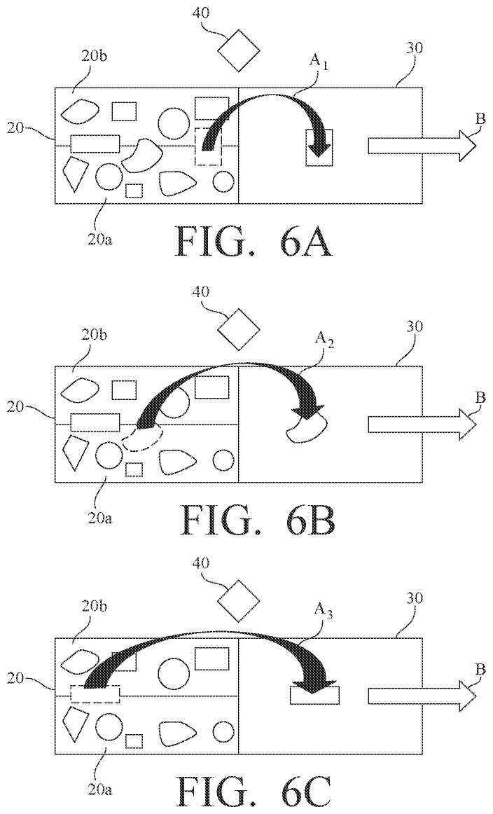

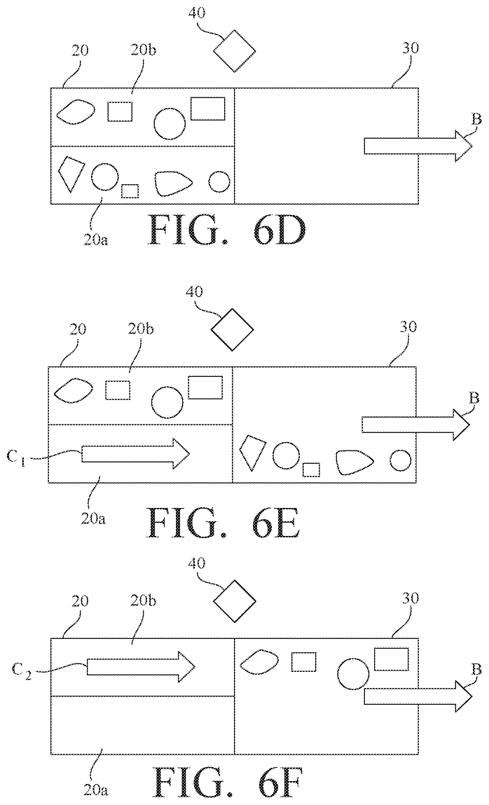

FIGS. 6A-6F are a sequence of schematic diagrams, illustrating the transfer of selected parcels from a first conveyor 20 to a second conveyor 30 in another exemplary implementation of the present invention. In this case, however, the first conveyor 20 is comprised of two side-by-side first conveyor segments 20a, 20b, which are independently controlled. As shown in this sequence, the robot 40 again selectively engages parcels in the bulk flow of parcels, one-by-one, placing each selected parcel on the second conveyor 30, as indicated by arrows A₁-A₃ in FIGS. 6A-6C. However, as shown, the robot 40 only transfers those parcels that are on the “border” between the first conveyor segments 20a, 20b. In this exemplary implementation, each parcel is placed on the second conveyor 30 at substantially the same location. As with the exemplary implementation described above with reference to FIGS. 5A-5I, as this transfer is occurring, the second conveyor 30 is activated (as indicated by arrow B) and thus moves each transferred parcel away from the robot 40.

Referring now specifically to FIGS. 6D-6F, after the above-described parcels have been transferred, by activating one first conveyor segment 20a (as indicated by arrow C₁ in FIG. 6E), the parcels on that first conveyor segment 20a are conveyed directly through to the second conveyor 30 in a single-file line. Similarly, by activating the other first conveyor segment 20b (as indicated by arrow C₂ in FIG. 6F), the parcels on that first conveyor segment 20b are also conveyed directly through to the second conveyor 30 in a single-file line. In this example, only three of the twelve parcels were engaged by the robot 40, representing a 75% decrease in pick moves by the robot 40.

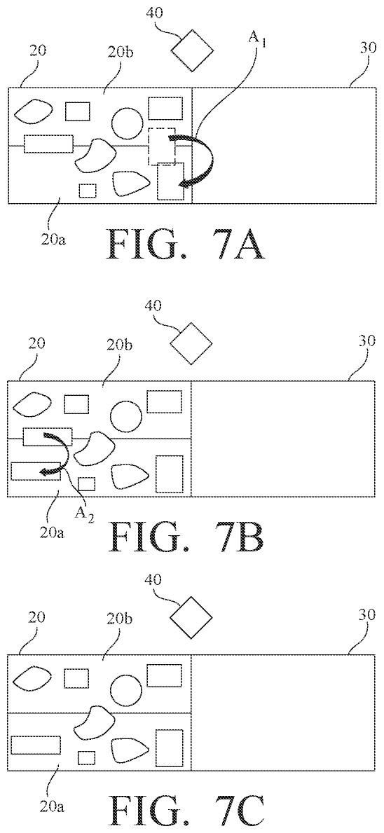

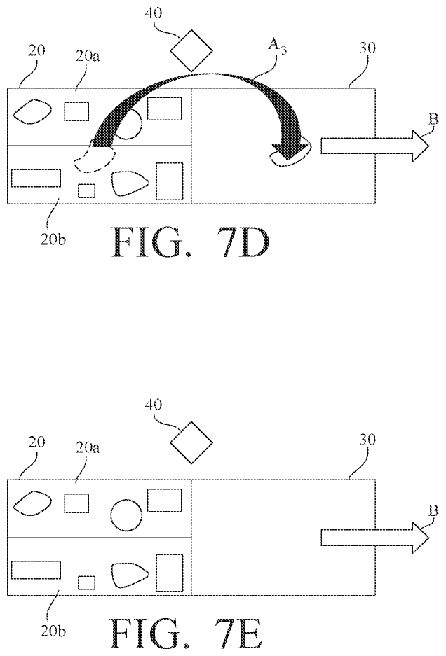

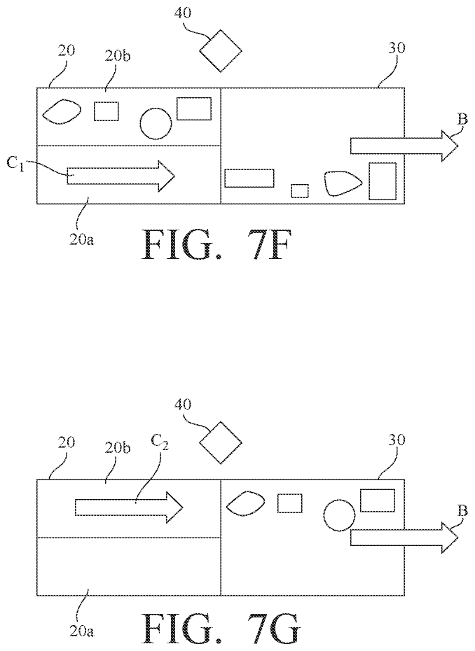

FIGS. 7A-7G are a sequence of schematic diagrams, illustrating the transfer of selected parcels from a first conveyor 20 to a second conveyor 30 in another exemplary implementation of the present invention. In this case, the first conveyor 20 is again comprised of two side-by-side first conveyor segments 20a, 20b, which are independently controlled. As shown in this sequence, the robot 40 again selectively engages parcels in the bulk flow of parcels, one-by-one. Similar to the exemplary implementation described above with respect to FIGS. 6A-6F, the robot 40 only transfers those parcels that are on the “border” between the respective first conveyor segments 20a, 20b. In this particular sequence, however, the robot 40 moves certain parcels that are on the “border” to a first conveyor segment 20a, rather than place them on the second conveyor 30, as indicated by arrows A₁ and A₂ in FIGS. 7A and 7B, respectively. Then, the robot 40 engages one remaining parcel on the “border,” moving it from the first conveyor 20 to the second conveyor 30, as indicated by arrow A₃ in FIG. 7D. As with the exemplary implementations described above with reference to FIGS. 5A-5I and FIGS. 6A-6F, as this transfer is occurring, the second conveyor 30 is activated (as indicated by arrow B) and thus moves the transferred parcel away from the robot 40.

Referring now specifically to FIGS. 7E-7G, after the above-described parcels have been transferred, by activating one first conveyor segment 20a (as indicated by arrow C₁ in FIG. 7F), the parcels on that first conveyor segment 20a are conveyed directly through to the second conveyor 30 in a single-file line. Similarly, by activating the other first conveyor segment 20b (as indicated by arrow C₂ in FIG. 7G), the parcels on that first conveyor segment 20b are also conveyed directly through to the second conveyor 30 in a single-file line.

In the example described above with respect to FIGS. 7A-7G, only three of the nine parcels were engaged by the robot 40, representing a 67% decrease in pick moves by the robot 40. Furthermore, two of these moves were for very short distances, moving a selected parcel from the “border” to the first conveyor segment 20a.

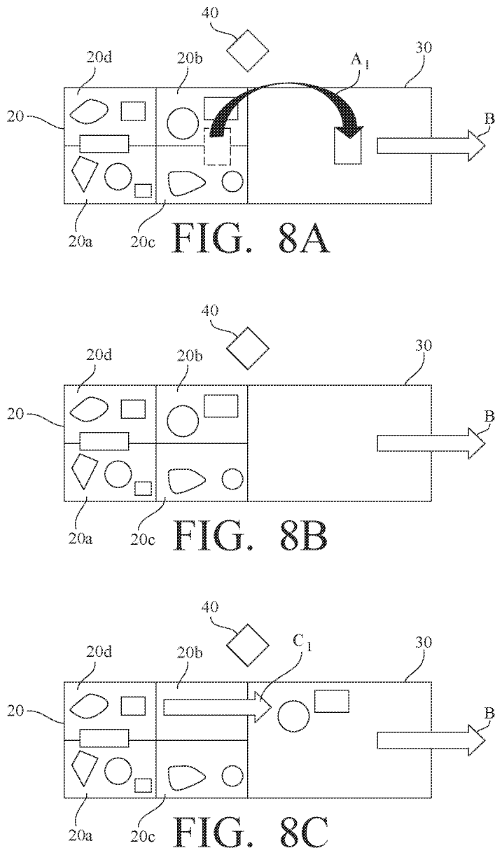

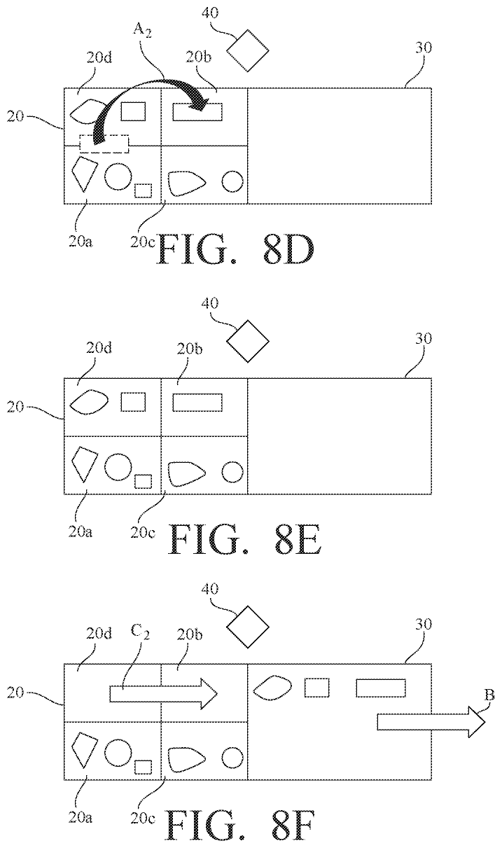

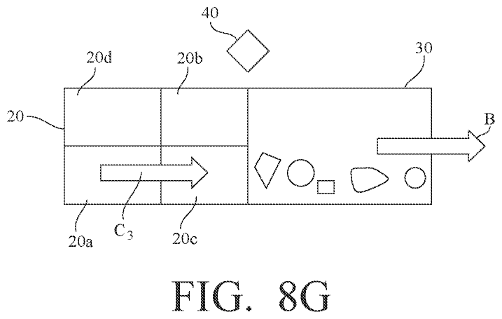

FIGS. 8A-8G are a sequence of schematic diagrams, illustrating the transfer of selected parcels from a first conveyor 20 to a second conveyor 30 in another exemplary implementation of the present invention. In this case, however, the first conveyor 20 is comprised of an inner set of first conveyor segments 20a, 20c and an outer set of first conveyor segments 20b, 20d, which are arranged in a matrix. Furthermore, each of the first conveyor segments 20a, 20b, 20c, 20d is independently controlled. As shown in this sequence, the robot 40 again selectively engages parcels in the bulk flow of parcels, one-by-one. Similar to the exemplary implementations described above with respect to FIGS. 6A-6F and FIGS. 7A-7H, the robot 40 first transfers those parcels that are on the “border” between the inner set of first conveyor segments 20a, 20c and the outer set of first conveyor segments 20b, 20d.

In this particular sequence, and referring now specifically to FIGS. 8A-8C, the robot 40 first moves a parcel that is on the “border” to the second conveyor 30, as indicated by arrow A₁ in FIG. 8A. As this transfer is occurring, the second conveyor 30 is activated (as indicated by arrow B) and thus moves the transferred parcel away from the robot 40. Then, by activating one first conveyor segment 20b (as indicated by arrow C₁ in FIG. 8C), the parcels on that first conveyor segment 20b are conveyed directly through to the second conveyor 30 in a single-file line.

Referring now specifically to FIG. 8D, the robot 40 then moves another parcel that is on the “border,” placing it not on the second conveyor 30, but rather placing it on the now vacant first conveyor segment 20b, as indicated by arrow A₂ in FIG. 8D.

Referring now specifically to FIG. 8E, the result is a single line of parcels on the first conveyor segment 20a and a single line of parcels on the first conveyor segment 20b.

Referring now specifically to FIG. 8F, by simultaneously activating the first conveyor segments 20b, 20d (as indicated by arrow C₂), the parcels on the first conveyor segments 20b, 20d are conveyed directly through to the second conveyor 30 in a single-file line.

Referring now specifically to FIG. 8G, by simultaneously activating the first conveyor segments 20a, 20b (as indicated by arrow C₃), the parcels on the first conveyor segments 20a, 20c are conveyed directly through to the second conveyor 30 in a single-file line.

In the example described above with respect to FIGS. 8A-8G, only two of the eleven parcels were engaged by the robot 40, representing a 82% decrease in pick moves by the robot 40. Furthermore, one of these moves was for a very short distance, moving a selected parcel from the “border” to the first conveyor segment 20b.

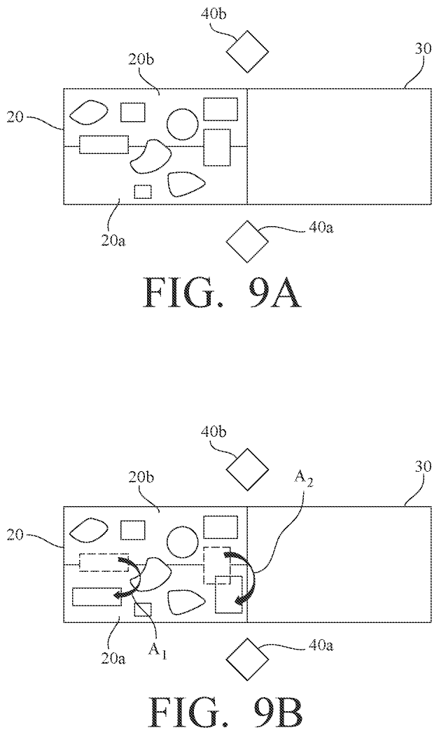

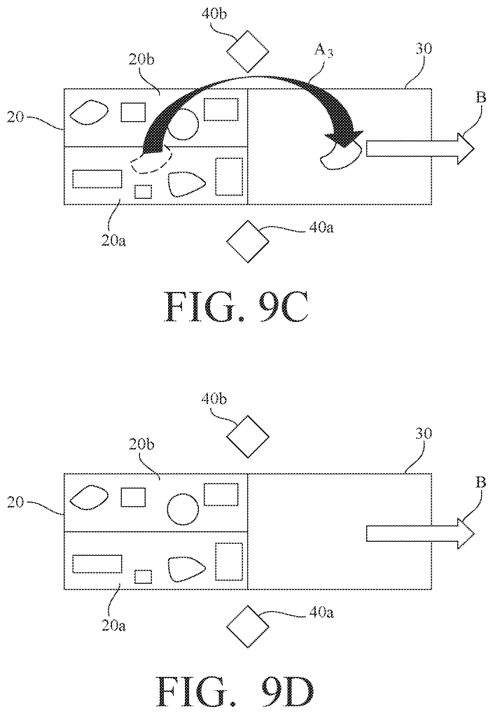

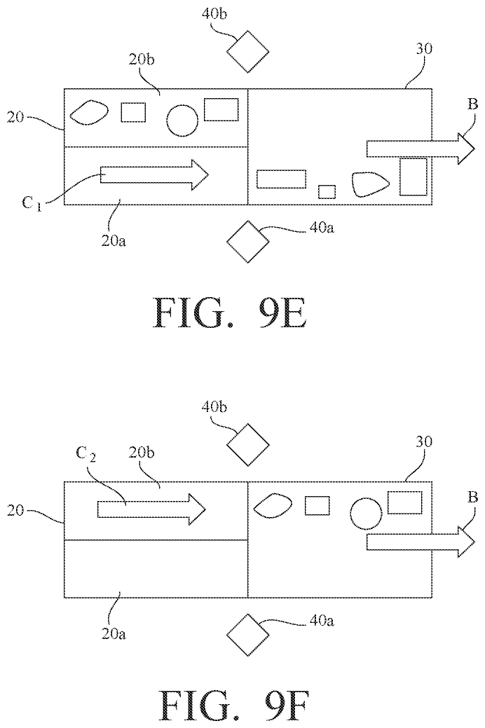

FIGS. 9A-9F are a sequence of schematic diagrams, illustrating the transfer of selected parcels from a first conveyor 20 to a second conveyor 30 in another exemplary implementation of the present invention. In this case, the first conveyor 20 is again comprised of two side-by-side first conveyor segments 20a, 20b, which are independently controlled. Furthermore, in this exemplary implementation, there is a first robot 40a and a second robot 40b. As shown in this sequence, the first robot 40a and the second robot 40b work together to selectively engage parcels in the bulk flow of parcels.

In this particular sequence, and referring now specifically to FIG. 9B, the first robot 40a first moves a parcel that is on the “border” to the first conveyor segment 20a, as indicated by arrow A₁ in FIG. 9B. At the same time, the second robot 40b moves another parcel that is on the “border” to the first conveyor segment 20a, as indicated by arrow A₂ in FIG. 9B.

Referring now specifically to FIG. 9C, the first robot 40a (or the second robot 40b) then moves another parcel that is on the “border,” but, this time, places it on the second conveyor 30, as indicated by arrow A₃ in FIG. 9C. As this transfer is occurring, the second conveyor 30 is activated (as indicated by arrow B) and thus moves the transferred parcel away from the robot 40.

Referring now specifically to FIG. 9D, the result is a single line of parcels on the first conveyor segment 20a and a single line of parcels on the first conveyor segment 20b.

Referring now specifically to FIG. 9E, by activating the first conveyor segment 20a (as indicated by arrow C₁), the parcels on the first conveyor segment 20a are conveyed directly through to the second conveyor 30 in a single-file line.

Referring now specifically to FIG. 9F, by activating the first conveyor segment 20b (as indicated by arrow C₂), the parcels on the first conveyor segment 20b are conveyed directly through to the second conveyor 30 in a single-file line.

In the example described above with respect to FIGS. 9A-9F, only three of the nine parcels were engaged by one of the robots 40a, 40b, representing a 67% decrease in pick moves by the robots 40a, 40b. Furthermore, two of these moves were performed simultaneously and were for very short distances.

Finally, it is contemplated that, in some implementations, additional robots could be used to improve efficiency and throughput.

As a further refinement, although not shown in the Figures, an exemplary system 10 made in accordance with the present invention could also include an unstacking conveyor, which would deliver the bulk flow of parcels to the first conveyor 20. Such an unstacking conveyor typically has an upward incline, such that the force of gravity causes parcels to unstack, and thus, the parcels will be in a single “layer” as they approach the robot 40, as further described in U.S. Pat. No. 10,646,898 (which has been incorporated herein by reference).

As a further refinement, although not shown in the Figures, an exemplary system 10 made in accordance with the present invention could also include one or more indexing conveyors, allowing parcels to be selectively advanced (or indexed) toward the first conveyor 20. In other words, the one or more indexing conveyors could be selectively activated and deactivated as part of a preconditioning of the flow of parcels, for example, by creating gaps in the flow of parcels, as further described in U.S. Pat. No. 10,646,898 (which has been incorporated herein by reference).

One of ordinary skill in the art will recognize that additional embodiments and implementations are also possible without departing from the teachings of the present invention. This detailed description, and particularly the specific details of the exemplary embodiments and implementations disclosed therein, is given primarily for clarity of understanding, and no unnecessary limitations are to be understood therefrom, for modifications will become obvious to those skilled in the art upon reading this disclosure and may be made without departing from the spirit or scope of the invention.

What is claimed is:

1. A system for identifying and transferring parcels, comprising:
a first conveyor carrying a bulk flow of multiple parcels;
a second conveyor aligned with the first conveyor, with a distal end of the first conveyor adjacent to a proximal end of the second conveyor;
a robot positioned at an interface between the first conveyor and the second conveyor, which is configured to engage and transfer selected individual parcels in the bulk flow of multiple parcels from the first conveyor to the second conveyor; and
a vision and control subsystem, including
a camera for acquiring image data of the bulk flow of multiple parcels, and
a computer including a processor for executing instructions stored in a memory component to (i) receive and process the image data from the camera to identify individual parcels in the bulk flow of multiple parcels, (ii) communicate instructions to the robot to engage and transfer selected individual parcels in the bulk flow of multiple parcels on the first conveyor to the second conveyor, and (iii) communicate instructions to the first conveyor to advance remaining parcels in the bulk flow of multiple parcels on the first conveyor to the second conveyor.

2. The system as recited in claim 1, wherein the processor of the computer also executes instructions stored in the memory component to selectively activate the second conveyor to move parcels away from the robot.

3. The system as recited in claim 1, wherein the first conveyor includes multiple conveyor segments, and wherein each of the multiple conveyor segments is independently controlled by and receives instructions from the computer.

4. The system as recited in claim 3, wherein the first conveyor includes two conveyor segments, which are in a side-by-side arrangement.

5. The system as recited in claim 3, wherein the first conveyor includes an inner set of conveyor segments and an outer set of conveyor segments, which are arranged in a matrix.

6. A method for identifying and transferring parcels from a first conveyor to a second conveyor aligned with the first conveyor, comprising the steps of:
using a camera to acquire image data of a bulk flow of multiple parcels on the first conveyor while the first conveyor is stationary;
using a computer to process the image data to identify individual parcels in the bulk flow of multiple parcels;
activating a robot to engage and transfer selected individual parcels in the bulk flow of multiple parcels from the first conveyor to the second conveyor in a predetermined sequence; and
activating the first conveyor to advance remaining parcels in the bulk flow of multiple parcels on the first conveyor to the second conveyor.

7. A system for identifying and transferring parcels, comprising:
a first conveyor carrying a bulk flow of multiple parcels, the first conveyor including multiple conveyor segments;
a second conveyor aligned with the first conveyor, with a distal end of the first conveyor adjacent to a proximal end of the second conveyor;
a robot positioned at an interface between the first conveyor and the second conveyor, which is configured to engage and transfer selected individual parcels in the bulk flow of multiple parcels from the first conveyor to the second conveyor; and
a vision and control subsystem, including
a camera for acquiring image data of the bulk flow of multiple parcels, and
a computer including a processor for executing instructions stored in a memory component to (i) receive and process the image data from the camera to identify individual parcels in the bulk flow of multiple parcels, (ii) communicate instructions to the robot to engage and transfer one or more of the individual parcels on the first conveyor to the second conveyor, (iii) communicate instructions to the robot to engage and transfer one or more individual parcels in the bulk flow of multiple parcels from one of the multiple conveyor segments of the first conveyor to another of the multiple conveyor segments of the first conveyor, and (iv) communicate instructions to the first conveyor to advance remaining parcels in the bulk flow of multiple parcels on the first conveyor to the second conveyor.

8. The system as recited in claim 7, wherein the processor of the computer also executes instructions stored in the memory component to selectively activate the second conveyor to move parcels away from the robot.

9. The system as recited in claim 7, wherein each of the multiple conveyor segments of the first conveyor is independently controlled by and receives instructions from the computer.

10. The system as recited in claim 9, wherein the first conveyor includes two conveyor segments, which are in a side-by-side arrangement.

11. The system as recited in claim 9, wherein the first conveyor includes an inner set of conveyor segments and an outer set of conveyor segments, which are arranged in a matrix.

12. A method for identifying and transferring parcels from a first conveyor to a second conveyor aligned with the first conveyor, comprising the steps of:
using a camera to acquire image data of a bulk flow of multiple parcels on the first conveyor while the first conveyor is stationary, wherein the first conveyor includes multiple conveyor segments;
using a computer to process the image data to identify individual parcels in the bulk flow of multiple parcels;
activating a robot to engage and transfer selected individual parcels in the bulk flow of multiple parcels from either (i) one of the multiple conveyor segments of the first conveyor to another of the multiple conveyor segments of the first conveyor, or (ii) the first conveyor to the second conveyor; and
activating the first conveyor to advance remaining parcels in the bulk flow of multiple parcels on the first conveyor to the second conveyor.
